(19) United States
(12) Patent Application Publication
(10) Pub. No.: US 2026/0064435 A1
(43) Pub. Date: Mar. 5, 2026

(54) METHOD AND SYSTEM FOR GENERATING CUSTOMIZABLE OPERATIONAL ENVIRONMENTS

(71) Applicant: JPMorgan Chase Bank, N.A., New York, NY (US)

(72) Inventors: Francesco CHIOCCOLA, Colchester (GB); Matthew LEGG, Windsor (GB); Arber BEQIRI, London (GB); Jacky HOU, London (GB); Paolo PARLAPIANO, London (GB)

(73) Assignee: JPMorgan Chase Bank, N.A., New York, NY (US)

(21) Appl. No.: 18/819,395

(22) Filed: Aug. 29, 2024

(51) Int. Cl. G06F 9/445

(52) U.S. Cl. CPC G06F 9/4451

(57) ABSTRACT

A method for providing customizable operational environments for automated real-time analysis is disclosed. The method includes receiving requests from a user via an application, each of the requests including a target and corresponding parameters for an operational environment; determining, by using a model, a listing of matching objects for each of the requests based on comparative analytics, the matching objects corresponding to the target; determining, by using the model, benchmark references for the target; identifying, by using the model, data sets that correspond to each of the matching objects, the data sets including historical data; retrieving the data sets from a data repository that is dynamically updated in real-time and from historical data sources; and displaying, via a graphical user interface, a graphical representation of the listing of the matching objects, the benchmark references, and the data sets.

### BACKGROUND

### 1. Field of the Disclosure

This technology generally relates to methods and systems for providing operational environments, and more particularly to methods and systems for generating customizable operational environments that facilitate automated analysis of predefined metrics in real-time.

### 2. Background Information

Many business entities maintain large collections of data to facilitate business operations and to provide services for users. Often, these large collections of data must be analyzed in an operational environment to provide usable information. Historically, implementations of conventional data analysis techniques have resulted in varying degrees of success with respect to generating best choices to assist users in selecting optimal outcomes for particular operational environments.

One drawback of the conventional data analysis techniques is that in many instances, generating the operational environments require careful selection of numerous parameters to ensure proper balance. As a result, generating operational environments in a workflow requires large investments in resources. Additionally, due to the required careful selection of numerous parameters, probability of introducing unwanted idiosyncratic risk and/or spurious correlations are high for relatively minor selection inconsistencies.

Therefore, there is a need for an automated process that effectively generates customizable operational environments to facilitate automated analysis of predefined metrics and predefined parameters in real-time.

### SUMMARY

The present disclosure, through one or more of its various aspects, embodiments, and/or specific features or sub-components, provides, inter alia, various systems, servers, devices, methods, media, programs, and platforms for generating customizable operational environments that facilitate automated analysis of predefined metrics in real-time.

According to an aspect of the present disclosure, a method for providing customizable operational environments for automated real-time analysis is disclosed. The method is implemented by at least one processor. The method may include receiving at least one request from a user via an application, each of the at least one request may include a target and at least one corresponding parameter for an operational environment; determining, by using at least one model, a listing of at least one matching object for each of the at least one request based on comparative analytics, the at least one matching object may correspond to the target; determining, by using the at least one model, at least one benchmark reference for the target; identifying, by using the at least one model, at least one data set that corresponds to each of the at least one matching object, the at least one data set may include historical data; retrieving the at least one data set from a data repository that is dynamically updated in real-time and from at least one historical data source; and displaying, via a graphical user interface, a graphical representation of the listing of the at least one matching object, the at least one benchmark reference, and the at least one data set.

In accordance with an exemplary embodiment, the graphical representation may include at least one graphical element that is configured to receive an input from the user, the input may include at least one action to alter the operational environment of the target.

In accordance with an exemplary embodiment, the graphical representation may include at least one heatmap that visually represents data for each of the at least one matching object based on predetermined criteria, the visual representation of the data may include a color coded representation of magnitude and degree of change.

In accordance with an exemplary embodiment, prior to the determining of the listing of the at least one matching object, the method may further include querying a caching layer for the operational environment; and determining, by using the at least one model, the listing of the at least one matching object when the operational environment is not cached in the caching layer.

In accordance with an exemplary embodiment, the method may further include persisting information that relates to the target and the corresponding at least one matching object in a caching layer, wherein the persisted information may be provided to a plurality of subsequent requests that include the target without requiring subsequent calculations.

In accordance with an exemplary embodiment, the at least one data set may include information that corresponds to at least one from among corporate action information, research reporting information, supply chain information, newsfeed information, and social media information.

In accordance with an exemplary embodiment, at least one correlation characteristic may be determined for each of the at least one matching object in the listing, the at least one correlation characteristic may include a correlation score that is calculated based on the target.

In accordance with an exemplary embodiment, the at least one correlation characteristic may include an anti-correlation characteristic that is usable to exclude data from further analysis, the excluded data may include an excluded time period.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a computing device configured to implement an execution of a method for providing customizable operational environments for automated real-time analysis is disclosed. The computing device including a processor; a memory; and a communication interface coupled to each of the processor and the memory, wherein the processor may be configured to receive at least one request from a user via an application, each of the at least one request may include a target and at least one corresponding parameter for an operational environment; determine, by using at least one model, a listing of at least one matching object for each of the at least one request based on comparative analytics, the at least one matching object may correspond to the target; determine, by using the at least one model, at least one benchmark reference for the target; identify, by using the at least one model, at least one data set that corresponds to each of the at least one matching object, the at least one data set may include historical data; retrieve the at least one data set from a data repository that is dynamically updated in real-time and from at least one historical data source; and display, via a graphical user interface, a graphical representation of the listing of the at least one matching object, the at least one benchmark reference, and the at least one data set.

In accordance with an exemplary embodiment, the graphical representation may include at least one graphical element that is configured to receive an input from the user, the input may include at least one action to alter the operational environment of the target.

In accordance with an exemplary embodiment, the graphical representation may include at least one heatmap that visually represents data for each of the at least one matching object based on predetermined criteria, the visual representation of the data may include a color coded representation of magnitude and degree of change.

In accordance with an exemplary embodiment, prior to the determining of the listing of the at least one matching object, the processor may be further configured to query a caching layer for the operational environment; and determine, by using the at least one model, the listing of the at least one matching object when the operational environment is not cached in the caching layer.

In accordance with an exemplary embodiment, the processor may be further configured to persist information that relates to the target and the corresponding at least one matching object in a caching layer, wherein the persisted information may be provided to a plurality of subsequent requests that include the target without requiring subsequent calculations.

In accordance with an exemplary embodiment, the at least one data set may include information that corresponds to at least one from among corporate action information, research reporting information, supply chain information, newsfeed information, and social media information.

In accordance with an exemplary embodiment, the processor may be further configured to determine at least one correlation characteristic for each of the at least one matching object in the listing, the at least one correlation characteristic may include a correlation score that is calculated based on the target.

In accordance with an exemplary embodiment, the at least one correlation characteristic may include an anti-correlation characteristic that is usable to exclude data from further analysis, the excluded data may include an excluded time period.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a non-transitory computer readable storage medium storing instructions for providing customizable operational environments for automated real-time analysis is disclosed. The storage medium including executable code which, when executed by a processor, may cause the processor to receive at least one request from a user via an application, each of the at least one request may include a target and at least one corresponding parameter for an operational environment; determine, by using at least one model, a listing of at least one matching object for each of the at least one request based on comparative analytics, the at least one matching object may correspond to the target; determine, by using the at least one model, at least one benchmark reference for the target; identify, by using the at least one model, at least one data set that corresponds to each of the at least one matching object, the at least one data set may include historical data; retrieve the at least one data set from a data repository that is dynamically updated in real-time and from at least one historical data source; and display, via a graphical user interface, a graphical representation of the listing of the at least one matching object, the at least one benchmark reference, and the at least one data set.

In accordance with an exemplary embodiment, the graphical representation may include at least one graphical element that is configured to receive an input from the user, the input may include at least one action to alter the operational environment of the target.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating customizable operational environments that facilitate automated analysis of predefined metrics in real-time.

FIG. 4 is a flowchart of an exemplary process for implementing a method for generating customizable operational environments that facilitate automated analysis of predefined metrics in real-time.

FIG. 5 is an architectural diagram of an exemplary process for implementing a method for generating customizable operational environments that facilitate automated analysis of predefined metrics in real-time.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

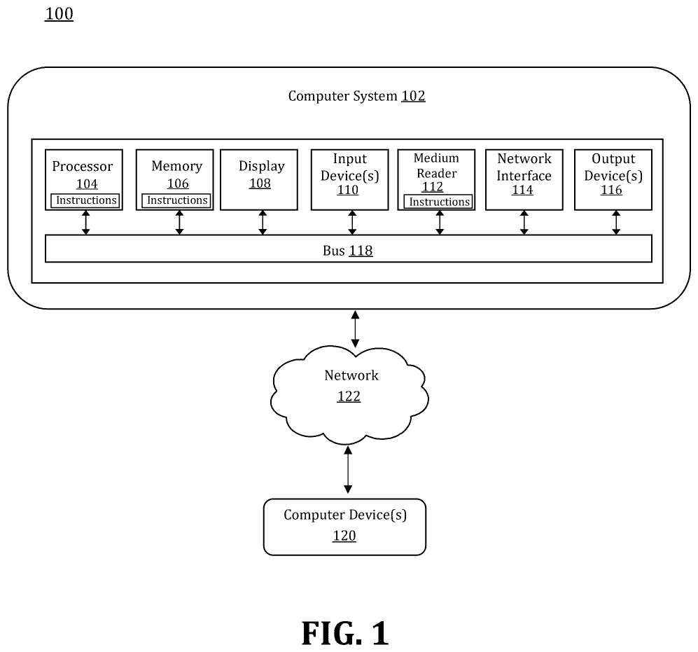

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating customizable operational environments that facilitate automated analysis of predefined metrics in real-time.

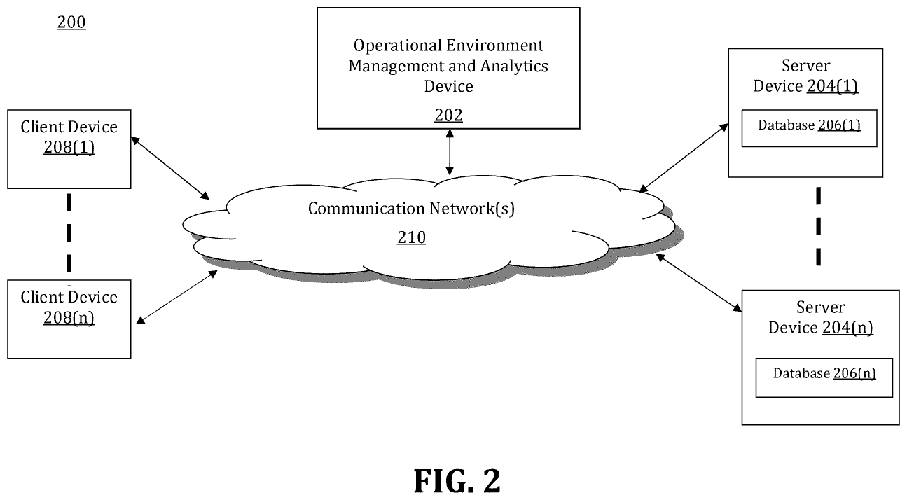

Referring to FIG. 2, a schematic of an exemplary network environment 200 for implementing a method for generating customizable operational environments that facilitate automated analysis of predefined metrics in real-time is illustrated. In an exemplary embodiment, the method is executable on any networked computer platform, such as, for example, a personal computer (PC).

The method for generating customizable operational environments that facilitate automated analysis of predefined metrics in real-time may be implemented by an Operational Environment Management and Analytics (OEMA) device 202. The OEMA device 202 may be the same or similar to the computer system 102 as described with respect to FIG. 1. The OEMA device 202 may store one or more applications that can include executable instructions that, when executed by the OEMA device 202, cause the OEMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OEMA device 202 itself, may be located in virtual server(s) running in a cloud-based computing environment rather than being tied to one or more specific physical network computing devices. Also, the application(s) may be running in one or more virtual machines (VMs) executing on the OEMA device 202. Additionally, in one or more embodiments of this technology, virtual machine(s) running on the OEMA device 202 may be managed or supervised by a hypervisor.

In the network environment 200 of FIG. 2, the OEMA device 202 is coupled to a plurality of server devices 204(1)-204(n) that hosts a plurality of databases 206(1)-206(n), and also to a plurality of client devices 208(1)-208(n) via communication network(s) 210. A communication interface of the OEMA device 202, such as the network interface 114 of the computer system 102 of FIG. 1, operatively couples and communicates between the OEMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OEMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OEMA devices that efficiently implement a method for generating customizable operational environments that facilitate automated analysis of predefined metrics in real-time.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OEMA device 202 may be a standalone device or integrated with one or more other devices or apparatuses, such as one or more of the server devices 204(1)-204(n), for example. In one particular example, the OEMA device 202 may include or be hosted by one of the server devices 204(1)-204(n), and other arrangements are also possible. Moreover, one or more of the devices of the OEMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OEMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user requests, parameters, operational environments, machine learning models, listings of matching objects, benchmark references, data sets, historical data, and graphical representations of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OEMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OEMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OEMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OEMA device 202, the server devices 204(1)-204(n), or the client devices 208(1)-208(n), for example, may be configured to operate as virtual instances on the same physical machine. In other words, one or more of the OEMA device 202, the server devices 204(1)-204(n), or the client devices 208(1)-208(n) may operate on the same physical device rather than as separate devices communicating through communication network(s) 210. Additionally, there may be more or fewer OEMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

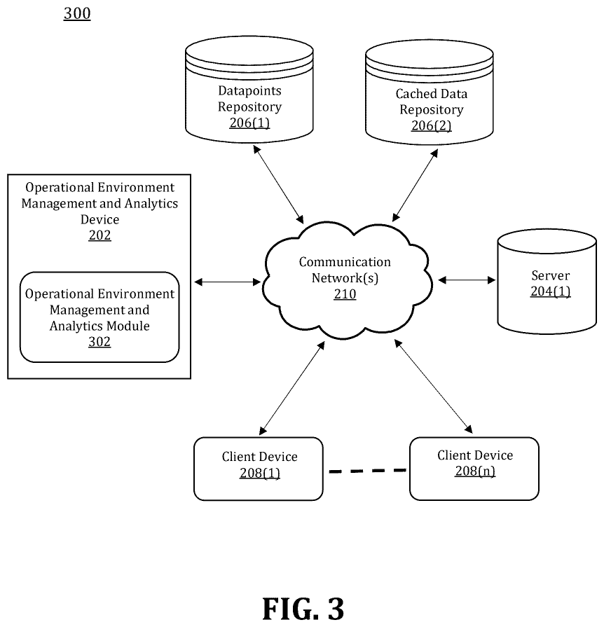

The OEMA device 202 is described and shown in FIG. 3 as including an operational environment management and analytics module 302, although it may include other rules, policies, modules, databases, or applications, for example. As will be described below, the operational environment management and analytics module 302 is configured to implement a method for generating customizable operational environments that facilitate automated analysis of predefined metrics in real-time.

An exemplary process 300 for implementing a mechanism for generating customizable operational environments that facilitate automated analysis of predefined metrics in real-time by utilizing the network environment of FIG. 2 is shown as being executed in FIG. 3. Specifically, a first client device 208(1) and a second client device 208(2) are illustrated as being in communication with OEMA device 202. In this regard, the first client device 208(1) and the second client device 208(2) may be “clients” of the OEMA device 202 and are described herein as such. Nevertheless, it is to be known and understood that the first client device 208(1) and/or the second client device 208(2) need not necessarily be “clients” of the OEMA device 202, or any entity described in association therewith herein. Any additional or alternative relationship may exist between either or both of the first client device 208(1) and the second client device 208(2) and the OEMA device 202, or no relationship may exist.

Further, OEMA device 202 is illustrated as being able to access a datapoints repository 206(1) and a cached data repository 206(2). The operational environment management and analytics module 302 may be configured to access these databases for implementing a method for generating customizable operational environments that facilitate automated analysis of predefined metrics in real-time.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OEMA device 202 via broadband or cellular communication. Of course, these embodiments are merely exemplary and are not limiting or exhaustive.

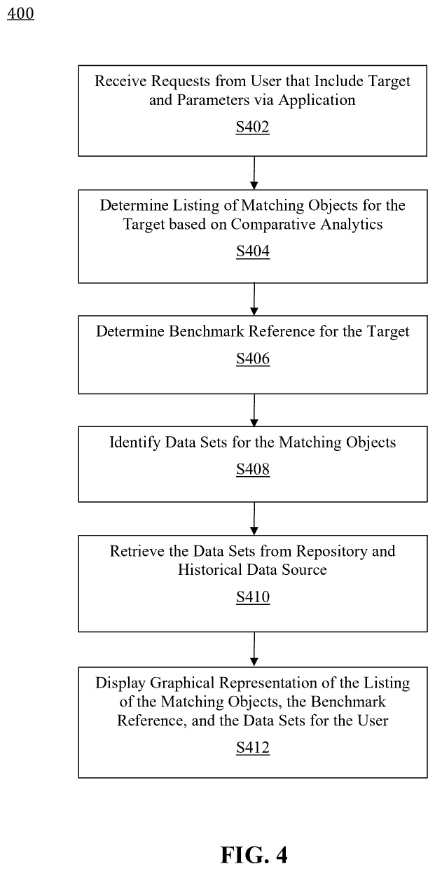

Upon being started, the operational environment management and analytics module 302 executes a process for generating customizable operational environments that facilitate automated analysis of predefined metrics in real-time. An exemplary process for generating customizable operational environments that facilitate automated analysis of predefined metrics in real-time is generally indicated at flowchart 400 in FIG. 4.

In the process 400 of FIG. 4, at step S402, requests may be received from a user. The requests may be received via an application that is associated with the disclosed system. In an exemplary embodiment, the requests may correspond to user inputs that provide instructions for the generation of an operational environment such as, for example, a universe for a specified target. Each of the requests may include target information such as, for example, a stock name and corresponding parameters such as, for example, a risk tolerance for the operational environment.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, a listing of matching objects may be determined for each of the requests. The listing of matching objects may be determined by using a model based on comparative analytic techniques. In an exemplary embodiment, the matching objects in the listing may correspond to the target. That is, the matching objects may be of a similar type and have similar characteristics as the target. For example, when the target is a particular stock, a listing of peer stocks may be determined for the target. The listing of the matching objects may be categorized in sub-groups and default sorted groups based on variables such as, for example, daily returns correlation variables.

In another exemplary embodiment, correlation characteristics may be determined for each of the matching objects in the listing. The correlation characteristics may include a correlation score that is calculated based on properties of the target. In another exemplary embodiment, the correlation characteristics may include an anti-correlation characteristic that is usable to exclude data from further analysis. The excluded data may include an excluded time period. For example, when information is known that data from a particular time period results in correlation errors for the matching objects, data from the particular time period may be automatically excluded from analysis.

In another exemplary embodiment, prior to the determining of the listing of the matching objects, a caching layer may be queried for the operational environment. Then, the listing of the matching objects may be determined when the requested operational environment is not cached in the caching layer. Consistent with present disclosures, the listing of matching objects may be determined based on a result of the querying by using the model.

In another exemplary embodiment, the model may include at least one from among a large language model, a deep learning model, a neural network model, a natural language processing model, a machine learning model, a mathematical model, and a process model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori Algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S406, benchmark references may be determined for the target. The benchmark references may be determined by using the model. In an exemplary embodiment, the benchmark reference may relate to a standard and/or point of reference against which the target may be compared and/or assessed. The benchmark reference may correspond to a standard that is usable to measure the change in the target's value and/or another metric over time. Benchmark references may be usable as reference points for the performance of the target as well as financial instruments such as, for example, securities, mutual funds, exchange-traded funds, and portfolios. The benchmark references may be categorized together with the listing of matching objects in sub-groups and default sorted groups based on variables such as, for example, daily returns correlation variables.

At step S408, data sets that correspond to each of the matching objects may be identified. The data sets may be identified by using the model. In an exemplary embodiment, the data sets may include historical data. The data sets may also include information that corresponds to at least one from among corporate action information, research reporting information, supply chain information, newsfeed information, and social media information.

In another exemplary embodiment, the data sets may be determined based on an overall contribution of a data type to the generation of the operational environment for the target. For example, when corporate action information disproportionately contributes to a risk analysis usable in the generation of the operational environment, data types and data sources associated with the corporate action information may be emphasized in the identification of the data sets. The emphasis may correspond to a weighing of the data types and the data sources in subsequent calculations.

At step S410, the data sets may be retrieved from a data repository that is dynamically updated in real-time. The data sets may also be retrieved from historical data sources such as, for example, from a price history database. In an exemplary embodiment, the data repository may automatically aggregate data such as, for example, market data by interacting with computing components such as, for example, basket data updaters and constituent updaters. The data repository may automatically aggregate the data in real-time, based on a predetermined schedule, as well as ad hoc based on predetermined guidelines. For example, the data repository may automatically aggregate the data in daily batch jobs according to a preset schedule. In another example, the data repository may determine that an ad hoc update is required when a threshold specified in the predetermined guidelines is satisfied.

At step S412, graphical representations may be displayed for the user via a graphical user interface. In an exemplary embodiment, the graphical representations may include information that corresponds to the listing of the matching objects, the benchmark references, and the data sets. The graphical representations may also include graphical elements that are configured to receive inputs from the user. The inputs may include actions to alter the operational environment of the target.

Further, the graphical representations may include heatmaps that visually represents data for each of the matching objects based on predetermined criteria such as, for example, a probability of an upcoming corporate action. The visual representation of the data may include a color coded representation of magnitude and degree of change. For example, the color coded representation may define a red color as having a high probability of occurrence and a green color as having a low probability of occurrence.

In another exemplary embodiment, the graphical user interface may include an interactive dashboard that is configured to receive input from the user the graphical user interface may relate to a software program that enables a person to communicate with a computing system though the user of symbols, graphical icons, and visual indicators. The graphical user interface may provide a visual way of interacting with the computing system.

In another exemplary embodiment, the dashboard may correspond to a type of graphical user interface that provides quick views of data relevant to an objective and/or process. The dashboard may provide these views through a combination of visualizations and summary information. The dashboard may provide access to the listing of the matching objects, the benchmark references, and the data sets. Functions within the dashboard may be usable to facilitate analysis of potential outcomes.

In another exemplary embodiment, workflows implemented via the dashboard may enable the user to quickly add objects such as, for example, financial instruments from a generated suggestion list such as, for example, a listing of matching objects to a desired operational environment as well as remove, refine, and iterate as many times as necessary. The user may have full flexibility in object selection and are able to select a subset of constituent objects from a basket. Once selections are made, the user of the dashboard may upload personalized benchmarks as well as personalized listings of objects for correlation based and other types of analysis. The dashboard may provide a reweighing functionality to update the operational environment when changes are made by the user.

In another exemplary embodiment, the determined operational environment may be persisted in the caching layer. To facilitate the caching, information that relates to the target and the corresponding matching objects may be persisted in the caching layer. The information may be associated with the particular target. The persisted information may be provided to a plurality of subsequent requests that include the particular target without requiring subsequent calculations. That is, by caching the determined operational environment for the particular target, access times may be reduced for subsequent users and resource consumption may be improved for the disclosed system by reducing duplicate calculations.

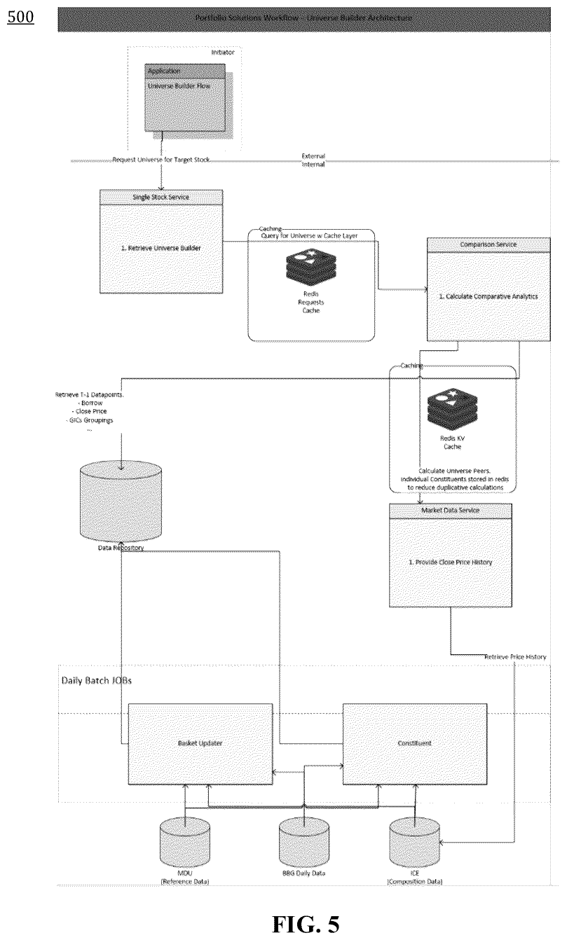

FIG. 5 is an architectural diagram 500 of an exemplary process for implementing a method for generating customizable operational environments that facilitate automated analysis of predefined metrics in real-time. In FIG. 5, a universe builder architecture is provided for portfolio solutions workflows. Consistent with present disclosures, the universe builder architecture may generate best choices across baskets, benchmarks, and object peers together with key metrics and analytics that are usable to assist users in managing target objects such as, for example, managing stock hedging.

As illustrated in FIG. 5, users may interact with a graphical user interface of an application to request generation of an operational environment for a target object. An initiator component of the application may interact with a target selection service component to retrieve the universe builder. The target selection service component may query a caching layer to manage user queries for the universe builder. This ensures that the user queries are efficiently processed without bandwidth issues affecting the universe builder.

Then, a comparison service component may process the request based on comparative analytics. Consistent with present disclosures, the comparison service component may perform comparative calculations to generate a listing of matching objects and corresponding benchmarks. The comparison service component may also access a data repository as well as a market data service component to retrieve necessary data. The data repository may interact with basket updater components and constituent updater components to retrieve data such as, for example, reference data, daily batch data, and composition data. Similarly, the market data service may interact with a historical data source to retrieve historical price data based on composition information. The market data service may provide close price history based on the retrieved historical price data.

Accordingly, with this technology, an optimized process for generating customizable operational environments that facilitate automated analysis of predefined metrics in real-time is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing customizable operational environments for automated real-time analysis, the method being implemented by at least one processor, the method comprising:
receiving, by the at least one processor, at least one request from a user via an application, each of the at least one request including a target and at least one corresponding parameter for an operational environment;
determining, by the at least one processor using at least one model, a listing of at least one matching object for each of the at least one request based on comparative analytics, the at least one matching object corresponding to the target;
determining, by the at least one processor using the at least one model, at least one benchmark reference for the target;
identifying, by the at least one processor using the at least one model, at least one data set that corresponds to each of the at least one matching object, the at least one data set including historical data;
retrieving, by the at least one processor, the at least one data set from a data repository that is dynamically updated in real-time and from at least one historical data source; and
displaying, by the at least one processor via a graphical user interface, a graphical representation of the listing of the at least one matching object, the at least one benchmark reference, and the at least one data set.

2. The method of claim 1, wherein the graphical representation includes at least one graphical element that is configured to receive an input from the user, the input including at least one action to alter the operational environment of the target.

3. The method of claim 1, wherein the graphical representation includes at least one heatmap that visually represents data for each of the at least one matching object based on predetermined criteria, the visual representation of the data including a color coded representation of magnitude and degree of change.

4. The method of claim 1, prior to the determining of the listing of the at least one matching object, further comprises:
querying, by the at least one processor, a caching layer for the operational environment; and
determining, by the at least one processor using the at least one model, the listing of the at least one matching object when the operational environment is not cached in the caching layer.

5. The method of claim 1, further comprising:
persisting, by the at least one processor, information that relates to the target and the corresponding at least one matching object in a caching layer,
wherein the persisted information is provided to a plurality of subsequent requests that include the target without requiring subsequent calculations.

6. The method of claim 1, wherein the at least one data set includes information that corresponds to at least one from among corporate action information, research reporting information, supply chain information, newsfeed information, and social media information.

7. The method of claim 1, wherein at least one correlation characteristic is determined for each of the at least one matching object in the listing, the at least one correlation characteristic including a correlation score that is calculated based on the target.

8. The method of claim 7, wherein the at least one correlation characteristic includes an anti-correlation characteristic that is usable to exclude data from further analysis, the excluded data including an excluded time period.

9. The method of claim 1, wherein the at least one model includes at least one from among a large language model, a deep learning model, a neural network model, a natural language processing model, a machine learning model, a mathematical model, and a process model.

10. A computing device configured to implement an execution of a method for providing customizable operational environments for automated real-time analysis, the computing device comprising:
a processor;
a memory; and
a communication interface coupled to each of the processor and the memory,
wherein the processor is configured to:
receive at least one request from a user via an application, each of the at least one request including a target and at least one corresponding parameter for an operational environment;
determine, by using at least one model, a listing of at least one matching object for each of the at least one request based on comparative analytics, the at least one matching object corresponding to the target;
determine, by using the at least one model, at least one benchmark reference for the target;
identify, by using the at least one model, at least one data set that corresponds to each of the at least one matching object, the at least one data set including historical data;
retrieve the at least one data set from a data repository that is dynamically updated in real-time and from at least one historical data source; and
display, via a graphical user interface, a graphical representation of the listing of the at least one matching object, the at least one benchmark reference, and the at least one data set.

11. The computing device of claim 10, wherein the graphical representation includes at least one graphical element that is configured to receive an input from the user, the input including at least one action to alter the operational environment of the target.

12. The computing device of claim 10, wherein the graphical representation includes at least one heatmap that visually represents data for each of the at least one matching object based on predetermined criteria, the visual representation of the data including a color coded representation of magnitude and degree of change.

13. The computing device of claim 10, wherein prior to the determining of the listing of the at least one matching object, the processor is further configured to:
query a caching layer for the operational environment; and
determine, by using the at least one model, the listing of the at least one matching object when the operational environment is not cached in the caching layer.

14. The computing device of claim 10, wherein the processor is further configured to:
persist information that relates to the target and the corresponding at least one matching object in a caching layer,
wherein the persisted information is provided to a plurality of subsequent requests that include the target without requiring subsequent calculations.

15. The computing device of claim 10, wherein the at least one data set includes information that corresponds to at least one from among corporate action information, research reporting information, supply chain information, newsfeed information, and social media information.

16. The computing device of claim 10, wherein the processor is further configured to determine at least one correlation characteristic for each of the at least one matching object in the listing, the at least one correlation characteristic including a correlation score that is calculated based on the target.

17. The computing device of claim 16, wherein the at least one correlation characteristic includes an anti-correlation characteristic that is usable to exclude data from further analysis, the excluded data including an excluded time period.

18. The computing device of claim 10, wherein the at least one model includes at least one from among a large language model, a deep learning model, a neural network model, a natural language processing model, a machine learning model, a mathematical model, and a process model.

19. A non-transitory computer readable storage medium storing instructions for providing customizable operational environments for automated real-time analysis, the storage medium comprising executable code which, when executed by a processor, causes the processor to:
receive at least one request from a user via an application, each of the at least one request including a target and at least one corresponding parameter for an operational environment;
determine, by using at least one model, a listing of at least one matching object for each of the at least one request based on comparative analytics, the at least one matching object corresponding to the target;
determine, by using the at least one model, at least one benchmark reference for the target;
identify, by using the at least one model, at least one data set that corresponds to each of the at least one matching object, the at least one data set including historical data;
retrieve the at least one data set from a data repository that is dynamically updated in real-time and from at least one historical data source; and
display, via a graphical user interface, a graphical representation of the listing of the at least one matching object, the at least one benchmark reference, and the at least one data set.

20. The storage medium of claim 19, wherein the graphical representation includes at least one graphical element that is configured to receive an input from the user, the input including at least one action to alter the operational environment of the target.
